(19) United States
(12) Patent Application Publication
(10) Pub. No.: US 2013/0266108 A1
(43) Pub. Date: Oct. 10, 2013

(54) WATER LEVEL DETERMINING METHOD FOR BOILING WATER REACTOR

(71) Applicants: Sheng-Yuan Fan, Taoyuan (TW); Shih-Jen Wang, Taoyuan (TW); Chih-Ming Tsai, Taoyuan (TW)

(72) Inventors: Sheng-Yuan Fan, Taoyuan (TW); Shih-Jen Wang, Taoyuan (TW); Chih-Ming Tsai, Taoyuan (TW)

(73) Assignee: INSTITUTE OF NUCLEAR ENERGY RESEARCH, ATOMIC ENERGY COUNCIL, EXECUTIVE YUAN, Taoyuan (TW)

(21) Appl. No.: 13/443,145

(22) Filed: Apr. 10, 2012

(51) Int. Cl. G21C 17/00

(52) U.S. Cl. 376/247

(57) ABSTRACT

The present invention discloses a water level determining method for a boiling water reactor. Thereby, for a boiling water reactor under anticipated transient without scram, risk of sudden power increase due to the uncertain water level raised to a main steam tube can be reduced by installing a thermometer on the top of the reactor or the main steam tube. By controlling flow rate of water and keeping the steam temperature higher than the saturated temperature, the core of the reactor can be sure to cool down properly.

### FIELD OF THE INVENTION

The present invention relates to a method for controlling water level of a boiling water reactor. More particularly, the present invention relates to a method for controlling water level of a boiling water reactor under anticipated transient without scram when the water level is hard to determine.

### BACKGROUND OF THE INVENTION

People paid more attention to nuclear safety after Three-Miles Island nuclear plant accident and Chernobyl disaster. Many groups started to simulate the behavior of a power plant under severe accidents to anticipate the phenomenon when the accidents happen. Thus, well preventions can be done to provide proper contingency measures and ensure safety of the power plant. Emergency Operation Procedure (EOP) is a reference of operation for operators when the accidents occur. Operators must mitigate the accidents and keep integrity of the power plant according to the instructions in EOP.

A standard boiling water reactor (BWR) includes a pressure container for installing a reactor core which is full of nuclear fuels inside. The reactor core is soaked in a circulating refrigerant, such as water, which can remove the heat generated from the nuclear fuels. Water is boiled to steam to drive a steam turbine generator to produce power. Then, the steam is cooled down. The water comes back to the pressure contain in a close-loop system. Pipelines take the steam to the turbine. Meanwhile, recycled water or supply water is led to the pressure container full of nuclear fuels.

The boiling water reactor comprises several known close-loop control systems which control the boiling water reactor individually in different ways in response to demands. For example, the Control Rod Driving Control System (CRDCS) control positions of the control rods in the reactor core so that the number of the control rods in the reactor core is under control. It determines the reaction in the reactor core and then the output power of the reactor core. The Recycling Flow Control System (RFCS) controls the flow rate in the reactor core. It changes the relationship of steam and water in the reactor core. Meanwhile, it is used to alter the output power of the reactor core. Those dual-control systems work with each other so that the output power of the reactor core in any point can be controlled in time. The Turbine Control System (TCS) controls the steam flow between the boiling water reactor and the turbine according to pressure adjustment or loadings.

Those systems and other control systems of the boiling water reactor utilize all kinds of monitored parameters of the boiling water reactor for controlling. Some monitored parameters includes: the flow and flow rate of the reactor under influence of the Recycling Flow Control System, the system pressure of the reactor, which is the steam pressure from the pressure containers to the turbine and can be measured on the top of the reactor or entrance of the turbine, neutron flux or power of the reactor core, temperature and flow rate of intake water, steam flow rate supplied to the turbine and all kinds of indicators for different situations in the boiling water reactor system. Many monitored parameters are directly measured. However, for parameters, such as thermal power of the reactor core, can be calculated by other parameters. The output values from the sensors and of the measured parameters are inputted into an emergency protection system to ensure safe power-off of the nuclear power plant, isolate the reactor from outside if needed, and prevent the reactor core from overheat during any emergency at the same time.

The Anticipated Transient Without Scram of the reactor (ATWS) means that the nuclear power plant has some Anticipated Operational Occurrences (AOO) which reaches the operating settings of the Reactor Protection System (RPS) but the Reactor Protection System is failed to stop the reactor. The Anticipated Operational Occurrence mentioned herein means it is expected to occur at least one time during the life time of the nuclear power plant. The request of the 10CFR 50.62 for the ATWS are: adding another set of recycled water bump terminating system, adding an alternative rod inserting system, increasing enrichment of boric acid, adding a set of automatically injecting boron system, and adding a set of automatic withdraw system for feed water. The first nuclear power plant in Taiwan has a Final Safety Analysis Report (FSAR). Section 15.8 mentions about improvement on related equipment for power plants toward the ATWS. With proper operations, probability of occurrence of the ATWS can be further reduced to mitigate the consequence after the ATWS takes place.

When the boiling water reactor nuclear power plant is in an abnormal state, operators lead the power plant to a safe situation according to the EOP. If the power plant is under the ATWS and control rods of the reactor can not been installed to stop the reactor, then, the power of the reactor will change with the reactor water level and pressure change. The power increases as well as the water level becomes higher. If the water level of the reactor can not been confirmed, water needs to pour to the reactor according to the EOP-C4. In order to make sure that the reactor core can be drown by water, the water level should be raised up the main steam tube according to the EOP to observe if the main steam tube contains water. It can determine that the reactor core is covered by cooling water as shown in FIG. 1. Thus, the reactor can prevent from protrusion out of the cooling water to further cause damage of the reactor core. However, under the ATWS, such action will increase the power of the reactor to reduce life time of the containment.

Current EOP of the power plant is written mainly according to the Emergency Procedure Guideline (EPG) issued by the Boiling Water Reactor Owner Group (BWROG) and then edited according to real situation and features of each power plant. The action is to delay applying of Severe Accident Guideline (SAG) and simply operation procedure. The procedure rises up the reactor water level to the main steam tube until water is detected in the vent pipe in the last stage. However, under the ATWS, increase of water level will cause increase of reactor power so that the containment speeds up to fail. How to monitor and control the water level the reactor core under the ATWS is an issue needs to breakthrough for the whole industry. A similar solution provided by Combustion Engineering Company is disclosed in R.O.C. Patent No. 285,740. Please refer to FIG. 2. A tank forms a chamber having an upper and lower region. The tank is in even elevation with a horizontal pipe having a top region and a bottom region. An upper connecting pipe fluidly connects the top region of the pipe to the top region of the tank. A lower connecting pipe fluidly connects the bottom region of the pipe to the lower region of the tank. Heat junction thermocouples generate a signal indicative of water in the pipe. The signal is transmitted to a remote location by lines.

The invention mentioned above utilizes principle of connecting pipe and is able to detect the water level of the reactor in the remote location. However, the method in the invention applies to the water level of a pressurized water reactor, not a boiling water reactor. Otherwise, the method is mainly applied to water level monitor in maintenance. It is unknown if it is applied to the reactor under the ATWS.

There are not many solutions in the industry to settle the problem mentioned above. Even the solutions exist, they are not effective. Therefore, a simple, effective and economical method to predict the water level of the core of a boiling water reactor under the ATWS is still desired.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

The present invention is a method for improving boiling water reactor power plant to determine water level when the water level is unsure under anticipated transient without scram (ATWS). The features and effects are:

1. A thermometer is installed on the top of the reactor or the steam tube to monitor the temperature in the top of the reactor and the pressure of the reactor. Thus, it is determined that if cooling water level is over the core of the reactor.

2. The invention is carried out by remote monitor to reduce industrial safety issues.

3. The invention provides an easy way with low cost.

4. The invention ensures the core of the reactor can be cooled down properly.

In order to obtain the targets mentioned above, the present invention provides a water level determining method for boiling water reactor under anticipated transient without scram, which includes the following steps: a) measuring temperature of the boiling water reactor; b) measuring pressure of the boiling water reactor; c) calculating a saturated temperature under the pressure; and d) determining that the water level is below the top of a core in the reactor if the temperature is higher than the saturated temperature; determining that the water level is above the top of the core if the temperature is lower than the saturated temperature.

Preferably, the boiling water reactor has a thermometer installed on the top thereof or the front of a main steam tube.

Preferably, the thermometer is a resistive type thermometer or thermocouple type thermometer

Preferably, the thermometer is covered by a protective well outside to protect the thermometer from damage of measured gas or liquid.

Preferably, the thermometer sends measured data to a remote monitoring equipment in form of an electrical signal.

Preferably, the boiling water reactor has a pressure sensor installed on an altitude that any designed cooling water level can not reach.

Preferably, the pressure sensor is installed above the main steam tube of the reactor.

Preferably, the pressure sensor is a Bourdon tube gauge, bellow type detector or differential pressure gage.

Preferably, the pressure sensor sends measured data to a remote monitoring equipment in form of an electrical signal.

### BRIEF DESCRIPTION OF THE DRAWINGS

FIG. 1 illustrates a conventional boiling water reactor.

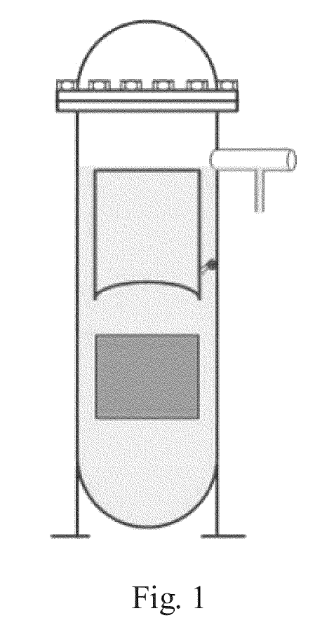

FIG. 2 shows a prior art in the related field of the present invention.

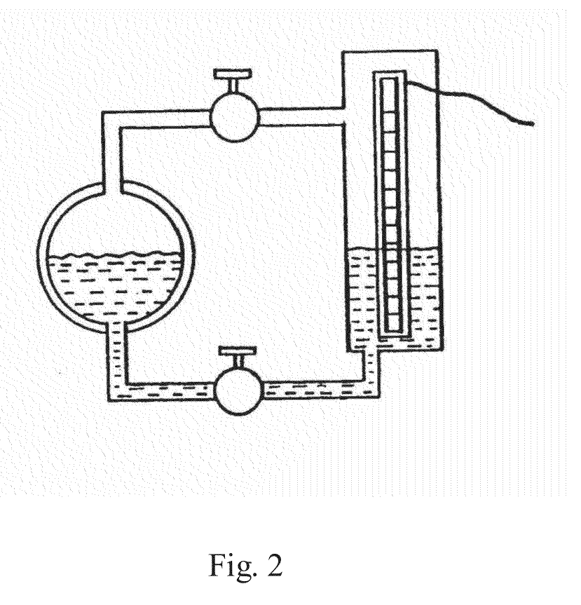

FIG. 3 illustrates an embodiment of the present invention.

FIG. 4 shows thermometers in different locations in the embodiment of the present invention.

FIG. 5 illustrates a protective well in the embodiment of the present invention.

FIG. 6 shows a remote monitoring condition in the embodiment of the present invention.

FIG. 7 is a flowchart of the present invention.

### DETAILED DESCRIPTION OF THE PREFERRED EMBODIMENT

The present invention will now be described more specifically with reference to the following embodiment. It is to be noted that the following descriptions of preferred embodiment of this invention are presented herein for purpose of illumination and description only; it is not intended to be exhaustive or to be limited to the precise form disclosed.

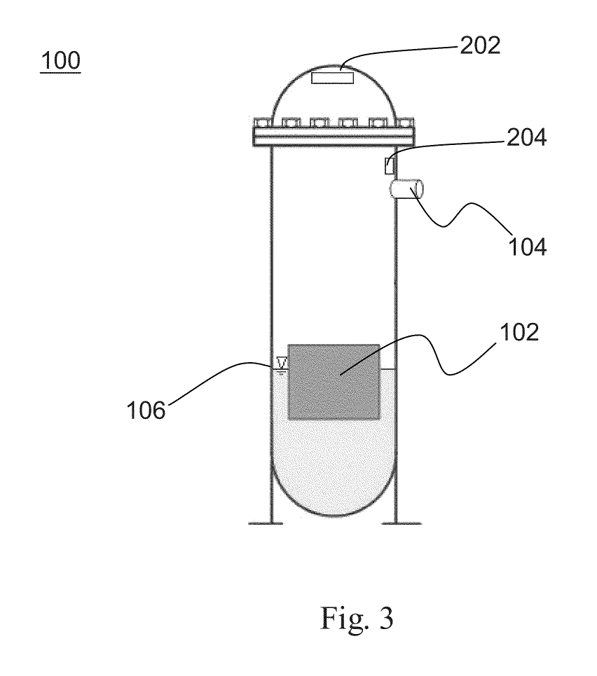

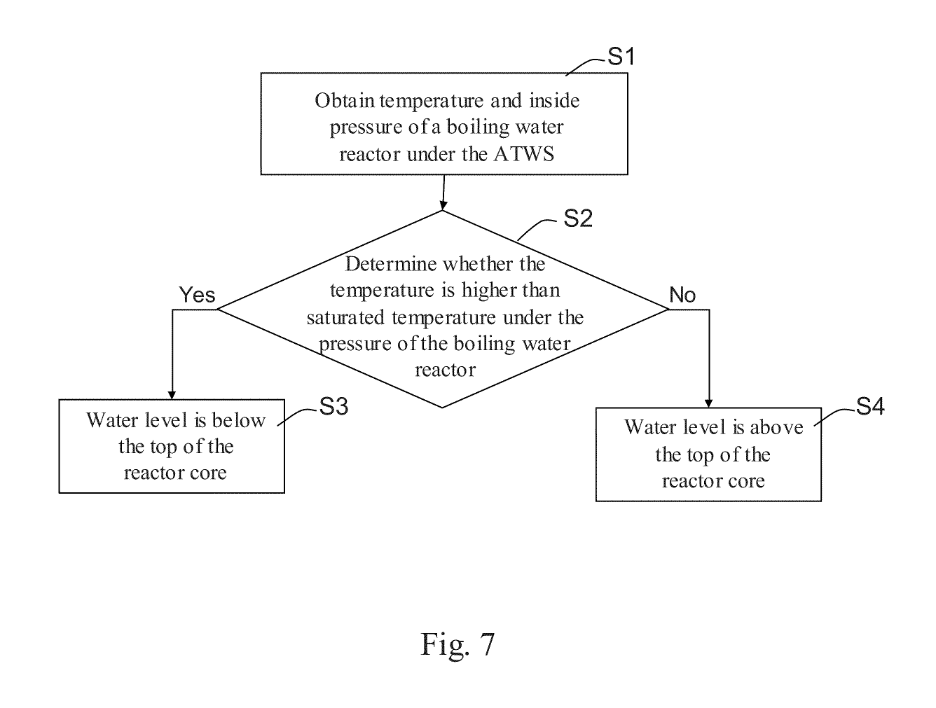

The present invention is illustrated in several schemes (FIG. 3 to FIG. 6) and a flowchart of water level determination (FIG. 7).

As mentioned above, when the power plant is under the ATWS and starts to fill water to the reactor according to the EPG, in order not to cause the risk of increasing power due to over water filling, the water level can be determined by the present invention. Please refer to FIG. 3. A boiling water reactor 100 comprises a reactor core 102 to process nuclear reaction and generate heat to run the power generation equipment. A related main steam tube 104 is used to lead the steam produced from the cooling water. When the amount of the cooling water exceeds an alert volume, it can be released by a vent pipe (not shown).

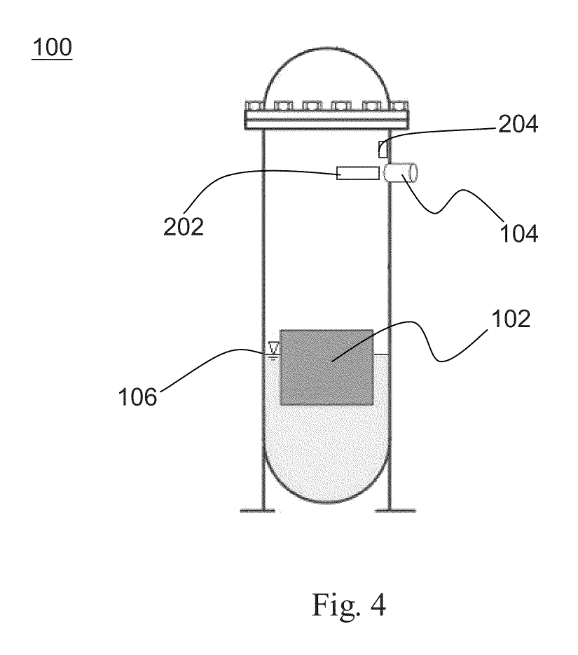

According to the present invention, a thermometer 202 is installed on the top of the boiling water reactor 100. The thermometer 202 can also be installed on the front of the main steam tube 102 of the boiling water reactor 100 (Please refer to FIG. 4). The function is to observe the temperature on the top of the boiling water reactor 100. The thermometer 202 used in the present embodiment is a resistive type thermometer. A commonly used thermocouple type thermometer is an alternative of the thermometer 202.

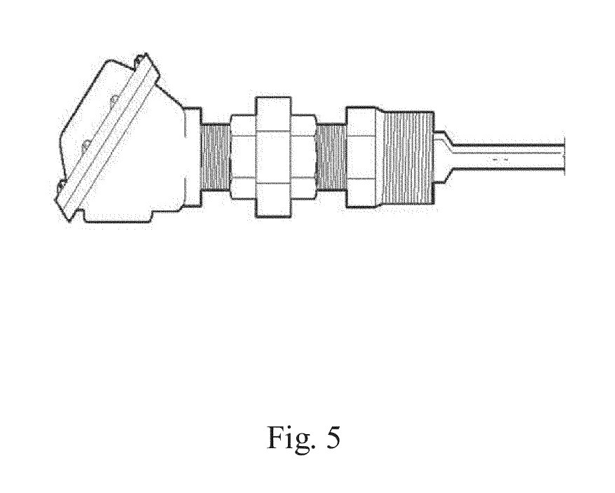

The resistive type thermometer is wildly used in many nuclear power plants is applied to monitor the temperature of the fluid or materials around. The operation principle of the resistive type thermometer is that when the temperature of the material changes, its resistance changes as well. A specified material, such as metal nickel, can demonstrate a relationship of much repeated characteristics between temperature and resistance. Due to the relationship, the temperature can be determined by measuring the resistance in the circuit or utility of the resistance. The structure of the resistive type thermometer is made of pure metal or specified alloys (mainly composed of platinum and copper). The resistance will increase as increase of the temperature. On the contrary, when the temperature is reduced, the resistance becomes lower. Behavior of the resistive type thermometer is like an electrical transducer. With the measured resistance, the temperature is transferred to a voltage signal. Preferably, the thermometer 202 used in the present embodiment can cover a protective well (not shown) and a terminal head. The protective well can protect the thermometer 202 from damages caused by measured gas or liquid. The protective well is usually made by stainless steel, carbon steel, inconel or cast iron. Working temperature can up to 1100° C. Please refer to FIG. 5 for the form of the protective well.

A pressure sensor 204 is installed inside the boiling water reactor 100 for monitoring the pressure in the boiling water reactor 100. In practice, the installed location of the pressure sensor 204 can be any altitude inside the boiling water reactor 100 where the designed water level of the cooling water can not reach. A preferable design is above the main steam tube 102. The pressure sensor 204 can be commonly used Bourdon tube gauge, bellow type detector or differential pressure gage. For a comprehensive illustration, a conventional bellow type detector is used in the present embodiment.

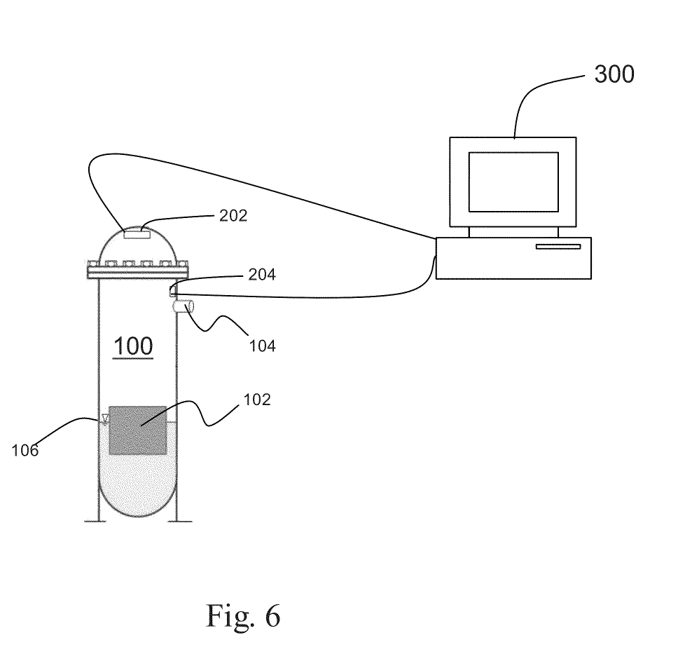

It should be noticed that in order to keep safety for the monitoring staffs and order to increase or decrease the amount of the cooling water in an engineer room at any time according to the temperature and pressure of the reactor core, the thermometer 202 and pressure sensor 204 can transmit the data to a remote monitoring equipment 300 (FIG. 6) in forma of an electrical signal. The remote monitoring equipment 300 is a workstation.

Regarding determining of water level 106, please refer to FIG. 7. Obtain the temperature value of the thermometer 202 (temperature on the top of the reactor) and pressure value (inside pressure) of the pressure sensor 204 under the ATWS (step S1) to determine whether the temperature is higher than saturated temperature under the pressure of the boiling water reactor 100 (step S2). If it is determined to be “yes”, then the water level 106 is below the top of the reactor core 102 in the boiling water reactor 100 (step S3); if it is determined to be “no”, then the water level 106 is above the top of the reactor core 102 in the boiling water reactor 100 (step S4).

By observing the temperature in the top of the reactor and the relationship with the saturated temperature to determine if the reactor core 102 is drowned by water, there is a reason: If the water level 106 inside is below the top of the reactor core 102, generated heat from the reactor core 102 will heat the water below into steam. When the steam passes a section of the reactor core 102 which is not drowned by the water, since the section of the reactor core 102 still generates heat and the heat keeps heating the saturated steam, the steam becomes super heat. Thus, by observing the temperature in the top of the boiling water reactor 100 and the pressure inside, it can be found that the temperature in the top of the boiling water reactor 100 is higher than the saturated temperature in the top of the boiling water reactor 100. It is determined that the water level 106 at this moment is below the top of the reactor core 102.

If the water level 106 is above the top of the reactor core 102, then the water is boiled and saturated. The temperature in the top of the boiling water reactor 100 equals to the saturated temperature. Therefore, by installing the thermometer 202 on the top of the boiling water reactor 100, it can be speculated if the reactor core 102 is properly cooled without using a water level gauge. If the temperature in the top of the boiling water reactor 100 is higher than the saturated temperature under the same pressure, it can be determined that the reactor core 102 has been exposed at this moment. On the contrary, if the temperature in the top of the boiling water reactor 100 is equal to or smaller than the saturated temperature under the same pressure, it can be determined that the reactor core 102 is drowned by water. When the ATWS happens during operation, the water level is unsure and the steam temperature in the top of the boiling water reactor 100 is observed. As long as the flow rate of intake water is controlled to keep the steam temperature in the top of the boiling water reactor 100 is a little higher than the saturated temperature, thus, it can be sure that the reactor core 102 is properly cooled down. It can also avoid over filling water to cause the problem of increase of power.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A water level determining method for boiling water reactor under anticipated transient without scram, comprising the following steps:
a) measuring temperature of the boiling water reactor;
b) measuring pressure of the boiling water reactor;
c) calculating a saturated temperature under the pressure; and
d) determining that the water level is below the top of a core in the reactor if the temperature is higher than the saturated temperature; determining that the water level is above the top of the core if the temperature is lower than the saturated temperature.

2. The water level determining method according to claim 1, wherein the boiling water reactor has a thermometer installed on the top thereof or the front of a main steam tube.

3. The water level determining method according to claim 2, wherein the thermometer is a resistive type thermometer or thermocouple type thermometer.

4. The water level determining method according to claim 2, wherein the thermometer is covered by a protective well outside to protect the thermometer from damage of measured gas or liquid.

5. The water level determining method according to claim 2, wherein the thermometer sends measured data to a remote monitoring equipment in form of an electrical signal.

6. The water level determining method according to claim 1, wherein the boiling water reactor has a pressure sensor installed on an altitude that any designed cooling water level can not reach.

7. The water level determining method according to claim 6, wherein the pressure sensor is installed above the main steam tube of the reactor.

8. The water level determining method according to claim 6, wherein the pressure sensor is a Bourdon tube gauge, bellow type detector or differential pressure gage.

9. The water level determining method according to claim 6, wherein the pressure sensor sends measured data to a remote monitoring equipment in form of an electrical signal.
